(19) United States
(12) Patent Application Publication
(10) Pub. No.: US 2013/0298441 A1
(43) Pub. Date: Nov. 14, 2013

(54) FISHING LURE

(71) Applicant: Kari Reis, Espoo (FI)

(72) Inventor: Kari Reis, Espoo (FI)

(21) Appl. No.: 13/981,437

(22) PCT Filed: Jan. 25, 2011
(86) PCT No.: PCT/FI11/50051

§ 371 Date: Jul. 24, 2013

(51) Int. Cl. A01K 85/01

(52) U.S. Cl. CPC A01K 85/01
USPC 43/35

(57) ABSTRACT

A fishing lure for trolling and casting. According to a preferable embodiment the lure of includes a body part having tracks formed in each side of the lure's body part, a hook for each track arranged to be movable along the track, latching elements for fastening the hooks to their activated state, a spring for each hook connected to the hook for pulling the hook forward along its track when the latching elements are released, a trigger for each hook extending along one side of the body part of the lure, which trigger, when an impact hits the trigger, releases the latching elements and enables the movement of the hook in its track. The latching elements are also released when an impact hits the hook itself.

### TECHNICAL FIELD

Generally, the invention relates to fishing equipment. More specifically, the invention relates to a fishing lure for trolling and casting.

### BACKGROUND TECHNOLOGY

Trolling or casting a lure is the most typical form of recreational fishing. Most recreational fishermen use a fishing rod with a fishing line and a lure at the end of the line or perform fly fishing with a line and a lure. The rod may be equipped with a reel so the line can be reeled in. Unfortunately, the catch is commonly minimal or non-existent, not because lack of fish in the sea but the time for fishing is wrong. The lure is used to attract predator fish to bite it and if predator fish are not hungry and preying right at the time, they do not strike. So as to catch a fish fishermen typically examine various tables, such as solunar tables, to be fishing in right time, i.e. when fish are preying.

If a fish bites the lure, a fisherman must be ready to strike back and hook the fish. So, traditionally the fisherman must hold a fishing line or rod in his hand and be ready for the action all the time. If the fish is not biting aggressively, it is very difficult to strike back just at right time and hook the fish. Therefore, in many cases the fish flees and the only thing the fisherman gets is a good story to tell.

Additionally, striking back is a tricky maneuver for an average fisherman, is has to be done at precisely right time with an adequate power and the average fisherman usually dares not to perform it being afraid of losing the fish. In addition, water and a stretching line hamper the striking back maneuver anyway, which makes it even harder to perform successfully.

When fishing in a boat, there may be multiple fishing rods sitting passively on rod rack during trolling, for example. In this situation, the striking back maneuver is impossible to perform and the only way to catch a fish is when it strikes the lure in order to eat it. However, it is commonly known that predator fish are curious animals and they defend their territory. So, they frequently come to probe the lure, even poke or snap it, also in those times they are not hungry. Therefore, fishermen typically experience couple of strokes on every fishing trip, but do not catch any fish.

Document U.S. Pat. No. 3,902,265A discloses a fishing lure in the form of a small fish having a groove extending along the bottom to the front end and having a hooked stud extending from the front end. A flat baffle slants down from the bottom toward the front end, the baffle having an opening through which the groove extends. A spring-steel wire leader has an upwardly slanted loop at the front end to which the line is tied, and an upwardly slanted loop at the rear end which locks the hook in place. A single large hook is provided with a downwardly slanted loop at the tie end which surrounds the shank of the leader, the leader loop at the rear end surrounding the shank of the hook, thus permitting relative sliding movement between the hook and the leader. The leader passes through the baffle opening with the hook to the rear. The hook and leader are placed in the groove, the lure having recesses for receiving the looped ends of the hook and leader. The front loop of the leader, with the line attached, is mounted on the stud. When a fish strikes, the hook and leader are instantly pulled from the stud and groove free of the lure, the lure being held captive by the leader passing through the baffle opening.

Document U.S. Pat. No. 5,809,685A discloses a fish hooking device including a hollow body having an elongated slot along one side and an eyelet opening in one end, a transverse pin axle in the body, a hook rotatable on the axle between a first retracted position in the body and a second extended position through the slot in the body, a hook extension formed with the hook from the other side of the axle, a hook release mounted on the axle extendable through the slot in the body, a hook release extension formed with the hook release along an opposite side of the axle, a spring mounted in the body having a first hook operator end curved to a normal position at which the hook is engaged by the spring and extended through the body slot to a position external of the body, a second latch end on the spring engageable with the hook extension to latch the hook at a re-tractable position and moveable to a hook release position by the hook release extension.

Unfortunately, both solutions presented in above documents have the same disadvantage; a fish has to bite the lure with great strength before the hook is released.

### SUMMARY OF THE INVENTION

The purpose of the present invention is to avoid or reduce the above disadvantages of the prior art.

The object of the invention is achieved with a solution, in which a fishing lure comprises at least one hook, which hook in its activated state is able to strike, when an impact releases the latching means fastening the hook.

A fishing lure for fishing according to the present invention is characterized by the features of claim 1.

Some preferable embodiments of the invention are described in the dependent claims.

According to a preferable embodiment the lure of the present invention comprises a body part having tracks formed in each side of the lure's body part, a hook for each track arranged to be movable along the track, latching means for fastening the hooks to their activated state, a spring for each hook connected to the hook for pulling the hook forward along its track when the latching means are released, a trigger for each hook extending along one side of the body part of the lure, which trigger, when an impact hits the trigger, releases the latching means and enables the movement of the hook in its track. The latching means are also released when an impact hits the hook itself.

In another embodiment, a track the hook moves along extends from near to the rear end of the lure's body part to at least e.g. halfway of the side from the rear end to the front end. Yet in another embodiment, the trigger extends over 50% of the length of the side between the front end and the rear end of the body part. Yet, in a further embodiment, the triggering area of the trigger and striking area of the hook are substantially congruent with each other.

In another embodiment, the hooks of the lure are located above and below of the lure's body.

Yet, in another embodiment, the body part of the invention is composed of modules, which modules are connectable with each other. In one embodiment, the striking parts comprising the hook/hooks, the spring/springs, latching means and the track/tracks for the hook are included in one of the modules. The other modules can be changeable forming a lure with varying size, color and/or features. In embodiments, wherein the striking parts further comprise the trigger/triggers, the trigger/triggers can also be included in the same module.

Significant advantages can be achieved with the present invention when compared to the prior known solutions. Firstly, trigger and strike areas of the lure according to the present invention are wide and congruent, which may improve the possibility to catch fish. The lure of the present invention may also be effective, because of a double trigger feature of the invention, i.e. both an impact to the hook and to the trigger may release the latching means. The latching means may be released even if the fish is only playing with the lure or poking it and the present invention may work especially well with boney jaw fishes like pike and pikeperch since the hook may pierce the jaw of the fish fast and firmly.

Furthermore, the lure according to the present invention may be simple to use, affordable and versatile. The lure can be composed of modules and the striking element comprising hooks, latching means, springs and tracks can be included in an independent module. By changing the other modules the features of the lure may be modified e.g. to dive deeper or swim shallower. In the same way, the color, size and appearance of the lure may be varied by changing the modules of the lure.

In addition, the invention may diminish the disadvantage of non-sharp hooks when the hook is struck to the fish with force. The striking is typically performed in the pulling direction of the lure, so the hooks, when released, may carry out an automatic striking back maneuver and the striking hooks of the present invention may hook the fish firmly. Moreover, when the caught fish is reeled in, the spring attached to the hook may attenuate fish kicks and thus assist the lifting process of the catch.

Finally, the hook of the present invention is firmly fastened to the lure when it is in its activated state, so it may not make as much noise as a normal hook hanging under the lure probably scaring fish away, and the hook is where fish hit to, which may further increase opportunities to catch fish.

### SHORT DESCRIPTION OF THE DRAWINGS

Next, the invention is described in more detail with reference to the appended drawings, in which

FIG. 1 illustrates a perspective view of a lure according to an embodiment of the present invention;

FIG. 2 illustrates a top view of a lure according to an embodiment of the present invention;

FIG. 3a illustrates an exploded view of a lure according to an embodiment of the present invention;

FIG. 3b illustrates another exploded view of a lure according to the embodiment in FIG. 3a;

FIG. 4 illustrates hooks and latching means of a lure according to an embodiment of the present invention.

### DETAILED DESCRIPTION OF THE EMBODIMENTS

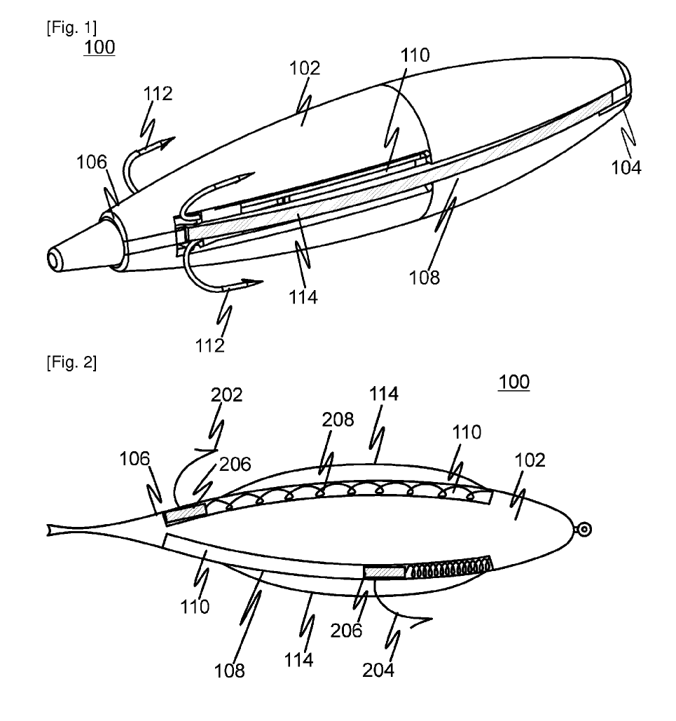

FIG. 1 illustrates a perspective view of a lure according to an embodiment of the present invention. The lure 100 comprises a body part 102 having a front end 104, a rear end 106 and at least one side 108 between the front end 104 and the rear end 106. Tracks 110 are formed in the side 108 of the body part 102. The lure 100 in FIG. 1 comprises two hooks 112, which hooks are arranged to be movable along the tracks 110. Additionally, the lure 100 comprises one trigger 114 for each hook, one spring attached to each hook and latching means for each hook, which spring and latching means are not shown in FIG. 1. For make it clearer, the trigger 114 is hatched in FIG. 1.

The trigger 114 is functionally connected to the latching means for releasing the latching means. The trigger 114 extends along one side of the body part in a direction substantially from the front end to the rear end of the body part. The length of the trigger, i.e. the triggering area, may vary, but preferably it is e.g. about 50%-95%, more preferably about 60%-90%, most preferably about 65%-85% of the length of the side between the front end and the rear end of the body part.

Even if the body part 102 of the lure 100 is tubular and the side 108 between the front end 104 and the rear end 106 continuous, right, left, top and bottom parts can still be denoted from the side of the body part depending on an angle of view.

The appearance of the lure may vary. Instead of the tubular form of the FIG. 1, the lure may resemble more like a fish or be thinner, for example. The material of body part of the lure can be any normally used material, such as wood, balsa, plastic, etc. Typically, the lure may further comprise other parts, such as lip/lips for controlling swimming, ring/rings for a fishing line, etc.

The function of the lure according to the present invention is described in further detail next. In FIG. 2 is illustrated a top view of the lure according to an embodiment of the present invention. FIG. 2 can also illustrate a side view of the lure according to another embodiment of the present invention. Each hook in the lure 100, both left hook 202 and right hook 204, is attached to a base 206, which base 206 is usually part of the latching means. The combination of the base 206 and the hook 202, 204 is arranged to be moveable along the track 110, which tracks 110 are formed in a shape of a groove and are arranged to span along the side 108 of the body part 102. Typically, a spring 208 attached to the base 206 is also arranged to locate in the track 110 and to stretch along the track 110.

The hooks can be activated, as the hook 202 in FIG. 2 shows, by fastening the hook 202,204 with latching means (not shown) to its activated state in the track 110 near to the rear end 106 of the body part 102. As the left hook 202 is activated, the spring 208 attached to it is stretched directing a pulling force to the base 206 the hook 202 is connected to. An impact to the activated hook 202 or to the trigger 114 connected to the latching means releases the latching means and the base 206 with the hook 202 is pulled forward along the track 110 by a force directed to it by the spring 208. In other words, when the latching means are released, the hook fastened by it strikes along its track 110. Usually, the hook is arranged to strike to the lure's pulling direction providing an automatic striking back maneuver. The right hook 204 depicts the hook in its unactivated state. Naturally, the right hook 204 can be activated and latch in the same way as described above for the left hook 202.

Springs used in this invention can be any typical spring suitable for the purpose, such as a metal spring made of e.g. steel, bronze, titanium, etc. Normally, the used springs are, for example, tension coil springs, but in some embodiments the spring are compression coiled springs directing a pushing force to the hook they are connected to. Yet, in another embodiment there are one or more compression coil springs and one or more tension coil springs for a hook arranged to both push and pull the hook in its track. In some embodiments, the hook is arranged to be attached straight to the spring without a base. In such cases, the hook can be considered as part of the latching means.

Yet, in some other embodiments, more than one spring is connected to a hook or a base, e.g. two springs. In these embodiments, the springs can be arranged so that both springs pull the hook/base or one spring is located in front of the hook/base for pulling it and the other behind the hook/base for pushing it.

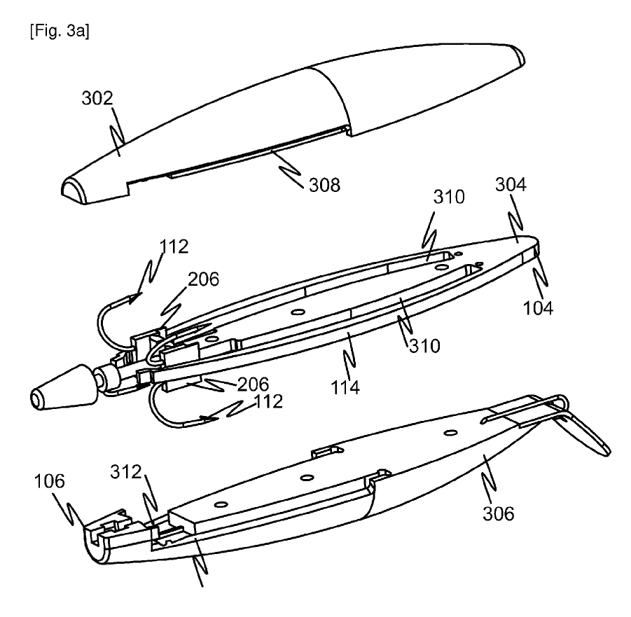

FIGS. 3a and 3b illustrate two exploded views of the lure according to an embodiment of the present invention. In an embodiment, the body part of the fishing lure according to the present invention is composed of modules, which modules are connectable with each other. The modules can be connected together with screws or hinges, for example, or with some other suitable means.

In FIGS. 3a and 3b, there are three modules composing the body part of the lure. The three modules form a top section 302, a middle section 304 and a bottom section 306 of the body part. Grooves 308, 310 and 312 are formed in the top, the middle and the bottom sections 302, 304, 306, respectively, both right and left sides of the sections. When the sections 302, 304 and 306 are connected together one above another, the grooves 308, 310 and 312 form together one larger groove, which groove acts as a track for the hook 112. The united groove extends from near to the rear end 106 of the body part to about halfway of the side from the rear end to the front end. The grooves 310 in the middle section are the longest grooves, because springs for the hooks 112 are disposed there. The shorter grooves 308, 312 halt the hook 112 in the end of its track. However, the grooves in the top and the bottom sections 308, 312 can be formed as long as the grooves in the middle section 310. The hook 112 is then halted by the spring.

In one preferred embodiment, the striking parts of the lure comprising hooks, latching means, springs and tracks are included in the middle section. In this embodiment, the other modules are changeable and can have various form, shape and color altering the appearance and/or features of the lure. The middle section can be composed of one module or, in some other embodiment, two or more modules.

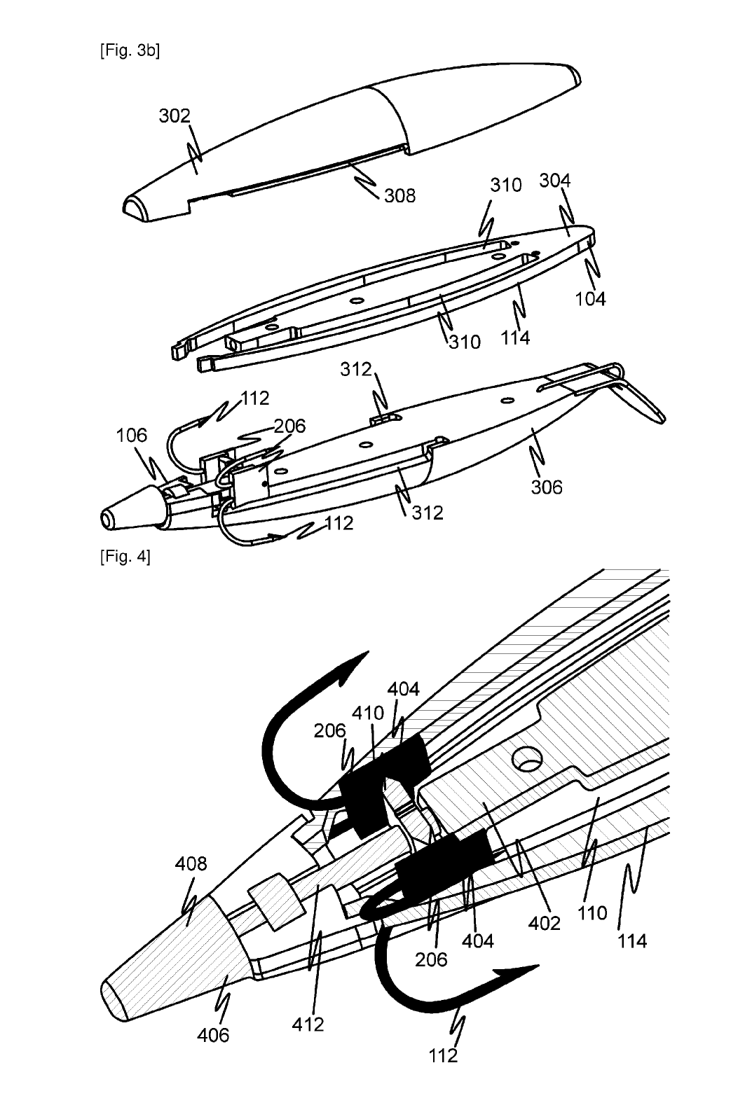

The hook 112 is placed to move in the united grooves 308, 310 and 312. Typically, the hook 112 is embedded to a base 206. Fastening of the hook 112 and the adjustment of the latching means are described in further detail below in conjunction with FIG. 4. The base 206, in turn, is attached to the one end of the spring. The other end of the spring is connected to the end of the groove 310 near to the front end 104 of the body part.

The lure according to the present invention may comprise more than two hooks or only one hook. The hooks, e.g. two or three hooks, can be embedded to the same base, for example, in which case they are considered as one hook in this document, and the lure can comprise e.g. about 1-6 bases.

Preferably, each base or each hook connected to a spring is arranged to function independently from the other hooks, i.e. the hooks can be activated separately and can strike independently. In some additionally embodiment, the hooks or at least some of the hooks in the lure are arranged to be activated together and/or to strike simultaneously.

The places of the hooks may vary depending on the embodiment, but preferably the hooks are arranged to strike from the rear end toward the front end of the body part. The hooks may be located to the bottom and/or top of the body part, upper sides and/or lower sides of the body part. In addition, hook may be located to the middle of the body part so that they can move from the middle to the front end of the body part. Typically, this way placed hooks are additional hooks for a hook or hooks moving from rear end.

The trigger 114 is formed in the middle section 304. The trigger 114 can be made of the same material as the middle section, such as plastic, or the trigger can be made of e.g. some metal, such as steel plate, and is connected to the middle section. The shape of the trigger can vary depending on the embodiment. The trigger can be flat or round or the trigger may have some other suitable shape. The width of the trigger can vary depending on the shape of it. In the middle, the trigger is usually wider and/or thicker and in the end(s) the trigger is usually narrower and/or thinner. If the trigger is round, it can have the same width and/or thickness all the way.

The fishing lure according the present invention can have several triggers for one latching means. In this case, the triggers can also extend along the middle section 304, the top section 302 and/or the bottom section 306, for example. The triggers can be formed in the sections or they can be separate attached to the lure.

In one embodiment, the body part is composed of more than three modules, such as four or five modules or even more. Yet, in another embodiment, the body part is composed of less than three modules, such as two modules. Typically, the modules are formed so that the hook/hooks can be placed between the modules or to a module, if the module has an opening for the hook, when the modules are not connected together, or as described above, hook/hooks can be included in one module. Instead of top and bottom sections, the modules can be provided so that they form side sections and/or front and rear sections, for example. It will be apparent to those skilled in the art that the modules can be provided so that they are combinations of what have been described above.

In some embodiments, grooves may be formed only to some sections, such as the middle and the top sections or the middle and the bottom sections or the groove for the hook is formed only in one section, e.g. middle section.

In some embodiments, springs are located in some other section than the middle, such as top or bottom section. In embodiments, where there is more than one spring for a hook, such as two springs, the springs can be located in the top and the bottom sections, for example.

Typically, the track for the hook is formed in the body part. The length of the track is provided so that the hook arranged to move along the track can strike more than 25% of the length of the side between the front end and the rear end of the body part. The length of the track is preferably e.g. about 25%-98%, more preferably about 40%-75%, most preferably about 45%-65% of the length of the side between the front end and the rear end of the body part. In some embodiments, the striking area of the hook, i.e. the length of the movement of the hook in its track, is substantially congruent with the triggering area of the trigger.

As described above, the track can be formed in a shape of a groove in the side of the body part. However, the track can also have some other form; the track can be in a shape of letter T, for example, on the side of the body part. In that case, the base of the hook can have groove-like form to match the track's shape. Yet in some other embodiment, the hook is kept in its track on the side of the body part by a spring or springs. The spring can arranged to pull the hook or one spring is arranged to pull the hook and the other to push it.

FIG. 4 illustrates hooks and latching means of a lure according to an embodiment of the present invention. In this embodiment, the base 206 and a middle member 402 form together the latching means. The base 206 is typically in the shape of plate having one elongated side forming an angle 404 in the base at the opposite end of which the hook 112 is embedded to. In the activated state of the hook 112, the base 206 is placed from the angle 404 to the middle member 402, which middle member 402 has a counterpart angle for the angle 404 of the base 206.

Adjusting means 406 (hatched with forward slanted lines in FIG. 4), for adjusting the releasing force of the latching means, are arranged in the rear end of the body part. An adjusting knob 408 are arranged to locate outside the lure for a user to screw the knob 408, which screwing dislocates an adjusting member 410, which adjusting member 410 can be like arrowhead moment arm pressing the base 206. The adjusting member moves forward or backward relative to a bar 412, which bar 412 is arrange to penetrate the adjusting member 410. Preferably, both the adjusting member 410 and the bar 412 are provided with threads. In addition, some indication of the adjustment can be provided to the user, e.g. a feelable click or snap when the adjusting knob is screwed, or some other indication. The adjusting member 410 depicted in FIG. 4 is in a shape of two-headed arrow, which both arrowheads act as a moment arm to both bases 206 in the latching means. As can be seen in figure, the more forward the adjusting member 410 is, the easier the angle 404 of the base 206 detaches from the middle member 402 and enables the base 206 with the hook 112 to move along the track 110.

It will be apparent to those skilled in the art that the lure may have an adjusting member with one arrowhead for adjusting the releasing force of one base or an adjusting member with three or four arrowhead for adjusting the releasing force of three or four bases, respectively.

In addition, it will be apparent to those skilled in the art that the adjusting member can have some other shape than the arrowhead.

The scope of the invention is determined by the attached claims together with the equivalents thereof. The skilled persons will again appreciate the fact that the explicitly disclosed embodiments were constructed for illustrative purposes only, and the scope will cover further embodiments, embodiment combinations and equivalents that better suit each particular use case of the invention.

1-13. (canceled)

14. Fishing lure for fishing comprising
a body part having a front end, a rear end and at least one side between the front end and the rear end, and
at least one track provided in conjunction with the body part,
at least one hook arranged to be moveable along the track,
at least one spring for one hook functionally connected from one end to the hook and from the other end to the body part,
latching means for fastening said hook to its activated state,
wherein, in the activated state, an impact to said hook is arranged to release the latching means and let the hook move along its track by a force directed by the spring.

15. The fishing lure according to claim 14, wherein said fishing lure further comprises at least one trigger for one hook extending along one side of the body part in a direction substantially from the front end to the rear end of the body part, and wherein an impact to said trigger releases the latching means.

16. The fishing lure according to claim 15, wherein the length of said trigger is 50% or more than the length of the side between the front end and the rear end of the body part.

17. The fishing lure according to claim 14, wherein said track is formed in a shape of a groove and said track is arranged to span along the side of the body part.

18. The fishing lure according to claim 14, wherein the length of a movement of said hook in the track is 25% or more of the length of the side between the front end and the rear end of the body part.

19. The fishing lure according to claim 15, wherein the striking area of the hook is substantially congruent with the triggering area of the trigger.

20. The fishing lure according to claim 14, wherein said activated state of the hook is in the side of the body part of the lure near to said rear end of the body part.

21. The fishing lure according to claim 14, wherein said fishing lure comprises more than one hook and a first hook is arranged to function independently from a second hook.

22. The fishing lure according to claim 14, wherein said string(s), after the latching means are released, direct(s) a pulling force to the hook it/they is/are connected to.

23. The fishing lure according to claim 14, wherein said string(s), after the latching means are released, direct(s) a pushing force to the hook it/they is/are connected to.

24. The fishing lure according to claim 14, wherein the body part is composed of at least two modules, which modules are connectable with each other.

25. The fishing lure according to claim 24, wherein striking parts comprising hook/hooks, spring/springs, track/tracks, latching means and/or trigger/triggers, are included in one of the modules.

26. The fishing lure according to claim 14, wherein the releasing force of the latching means is adjustable.
